(19) United States
(12) Patent Application Publication
(10) Pub. No.: US 2012/0317253 A1
(43) Pub. Date: Dec. 13, 2012

(54) INFORMATION PROCESSING DEVICE, SETTINGS CHANGING METHOD AND COMPUTER READABLE RECORDING MEDIUM

(75) Inventor: Hiroaki MAEKAWA, Amagasaki-shi (JP)

(73) Assignee: Konica Minolta Business Technologies, Inc., Chiyoda-ku (JP)

(21) Appl. No.: 13/494,753

(22) Filed: Jun. 12, 2012

(30) Foreign Application Priority Data
Jun. 13, 2011 (JP) 2011-131032

(51) Int. Cl. G06F 15/177

(52) U.S. Cl. 709/221

(57) ABSTRACT

An information processing device connected with a plurality of devices through a network, comprises: a scheduling part for configuring a change date and time to change settings for each of the plurality of devices; a device status determination part for determining if each of the plurality of devices is ready for settings change at the same time as the scheduled change time on the day before the scheduled change date; a device status controlling part for causing the device not ready for the settings change to become ready for the settings change on the scheduled change date and time when it is determined by the device status determination part that one or more of the plurality of devices are not ready for the settings change; and a settings changing part for changing the settings for each of the plurality of devices on the scheduled change date and time.

This application is based on the application No. 2011-131032 filed in Japan, the contents of which are hereby incorporated by reference.

### BACKGROUND OF THE INVENTION

1. Field of the Invention

The present invention relates to an information processing device, a settings changing method and a computer readable recording medium. The present invention more specifically relates to a technique of changing settings for devices connected together through a network.

2. Description of the Background Art

Wireless network settings for a communication control device and all client devices are changed in a synchronized timing in response to input of information as to update of wireless network settings from one of the client devices on conventional wireless network systems. This known technique is introduced for example in Japanese Patent Application Laid-Open No. JP2010-98768 A. According to the known technique, wireless network settings for every client computer are changed in the synchronized timing at settings change. The wireless network settings for some client computers may not be changed because of timeout or other events. Those conventional client computers that are not allowed to be changed in the synchronized timing at the settings change are listed and displayed, so that users are guided to configure the settings again.

Some users in these days desire to change settings for various types of information devices connected together through a network, not limited to the settings regarding wireless network, all at once in the synchronized timing. That is, for example, for setting an internal clock of every information device to adjust daylight saving time from standard time. Also, that may be for changing billing maps in which values such as billing unit prices are set and which is referred in a process such as a billing process in each information device. In those cases, unless settings for all of the plurality of information devices connected through the network should be changed collectively at the same time, the settings for each information device may have inconsistency with each other. When the settings for one or more information devices are inconsistent with those for other devices, the settings failed to be changed for the information devices are configured again later. Thus, the settings for the information devices are changed to be the same settings for other information devices.

Some process may be performed in the information device, the settings for which are failed to be changed at the time that all of the settings are to be changed by the time that the change of the settings are complete. The information device then may record wrong information that comes from the unchanged settings as history information when information including execution time of the process or a billing amount charged for execution of the process is recorded as the history information, which involves a problem.

### SUMMARY OF THE INVENTION

The present invention is intended to solve the above problems. Thus, the present invention is intended to provide an information processing device, a settings changing method and a computer readable recording medium capable of reducing the occurrence of devices, the settings for which are failed to be changed at the time that settings for all devices should be changed collectively.

First, the present invention is directed to an information processing device connected with a plurality of devices through a network.

According to one aspect of the information processing device, the information processing device, comprises: a scheduling part for configuring a change date and time to change settings for each of the plurality of devices; a device status determination part for determining if each of the plurality of devices is ready for settings change at the same time as the scheduled change time on the day before the scheduled change date; a device status controlling part for causing the device not ready for the settings change to become ready for the settings change on the scheduled change date and time when it is determined by the device status determination part that one or more of the plurality of devices are not ready for the settings change; and a settings changing part for changing the settings for each of the plurality of devices on the scheduled change date and time.

Second, the present invention is directed to a settings changing method for changing settings for a plurality of devices connected together through a network.

According to one aspect of the settings changing method, the settings changing method, comprises the steps of: (a) configuring a change date and time to change the settings for each of the plurality of devices; (b) determining if each of the plurality of devices is ready for settings change at the same time as the scheduled change time on the day before the scheduled change date; (c) causing the device not ready for the settings change to become ready for the settings change on the scheduled change date and time when it is determined in the step (b) that one or more of the plurality of devices are not ready for the settings change; and (d) changing the settings for each of the plurality of devices on the scheduled change date and time.

Third, the present invention is directed to a computer readable recording medium on which a program is recorded. The program is executable by an information processing device connected together with a plurality of devices through a network.

According to an aspect of the computer readable recording medium, the program causes information processing device to function as a system comprising: a scheduling part for configuring a change date and time to change settings for each of the plurality of devices; a device status determination part for determining if each of the plurality of devices is ready for settings change at the same time as the scheduled change time on the day before the scheduled change date; a device status controlling part for causing the device not ready for the settings change to become ready for the settings change on the scheduled change date and time when it is determined by the device status determination part that one or more of the plurality of devices are not ready for the settings change; and a settings changing part for changing the settings for each of the plurality of devices on the scheduled change date and time.

### BRIEF DESCRIPTION OF THE DRAWINGS

FIG. 1 shows an exemplary configuration of a network system;

FIG. 2 is a block diagram showing the hardware configuration of an information device;

FIG. 3 shows the transition of the status of power supply in the information device;

FIG. 4 is a block diagram showing the hardware configuration of an information processing device;

FIG. 5 shows an example of device management information stored in advance in a storage device in the information processing device;

FIG. 6 is a block diagram showing the functional configuration realized by execution of a program by a CPU in the information processing device;

FIG. 7 shows an example of settings information registered by a scheduling part;

FIG. 8 is a flow diagram explaining an exemplary sequential procedure of the process performed by the CPU in the information processing device;

FIG. 9 is a flow diagram explaining in detail an exemplary process sequence of a device status determination;

FIG. 10 is a flow diagram explaining in detail an exemplary process sequence of a collective settings change; and

FIG. 11 is a flow diagram explaining in detail an exemplary process sequence of an unconfigured settings changing process.

### DESCRIPTION OF THE PRESENT PREFERRED EMBODIMENTS

A present preferred embodiment of the present invention is described in detail below with reference to figures. In the description given below, those elements which are shared in common among figures are represented by the same reference numerals, and these elements are not discussed repeatedly for the same description.

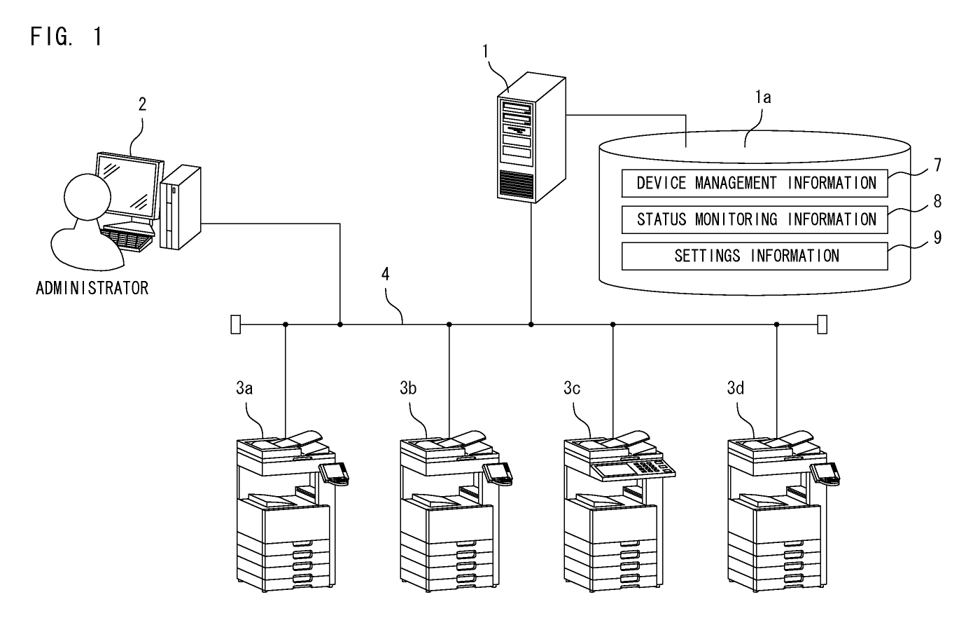

FIG. 1 shows an exemplary configuration of a network system of the preferred embodiment of the present invention. The network system includes an information processing device 1, a computer 2 and a plurality of information devices 3a, 3b, 3c and 3d that are connected to each other through a network 4 such as LAN (Local Area Network).

The information processing device 1 formed from a server computer, for example, manages the plurality of information devices 3a, 3b, 3c and 3d through the network 4. The information processing device 1 is capable of changing the settings for the plurality of information devices 3a, 3b, 3c and 3d through the network 4.

The computer 2 is formed from a generally-used personal computer (PC) or the like. The computer 2 is available for an administrator of the network system, for instance. The administrator operates the computer 2, thereby giving instructions on date and time for the lump change of the settings for the plurality of information devices 3a, 3b, 3c and 3d or instructions on changes of the settings.

Each of the plurality of information devices 3a, 3b, 3c and 3d is a device such as one of MFPs, a printer or a facsimile. All of the plurality of information devices 3a, 3b, 3c and 3d of the present preferred embodiment are formed from MFPs. Since all of the plurality of information devices 3a, 3b, 3c and 3d are MFPs, functions on each information device may differ. The number of the plurality of information devices of FIG. 1 connected together through the network 4 is four, which is 3a, 3b, 3c and 3d. More or less than four information devices may be connected.

The information processing device 1 includes a storage device 1a formed from a nonvolatile storage device such as a hard disk drive. The storage device 1a stores therein device management information 7, status monitoring information 8 and settings information 9. The device management information 7 is information in which information as to the plurality of information devices 3a, 3b, 3c and 3d being managed by the information processing device 1 are registered in advance. Operating status of every information device 3a, 3b, 3c and 3d is recorded as the status monitoring information 8. The information processing device 1 is configured to monitor operating status of each of the information devices 3a, 3b, 3c and 3d through the network 4 periodically, and results of the periodic monitoring are recorded as the status monitoring information 8. The settings information 9 is information in which date and time to change the settings specified by the computer 2 is stored by the information processing device 1.

With the settings information 9 stored in the storage device 1a, the information processing device 1 changes the settings for the plurality of information devices 3a, 3b, 3c and 3d collectively on date and time when the settings should be changed (hereafter, change date and time) registered in the settings information 9.

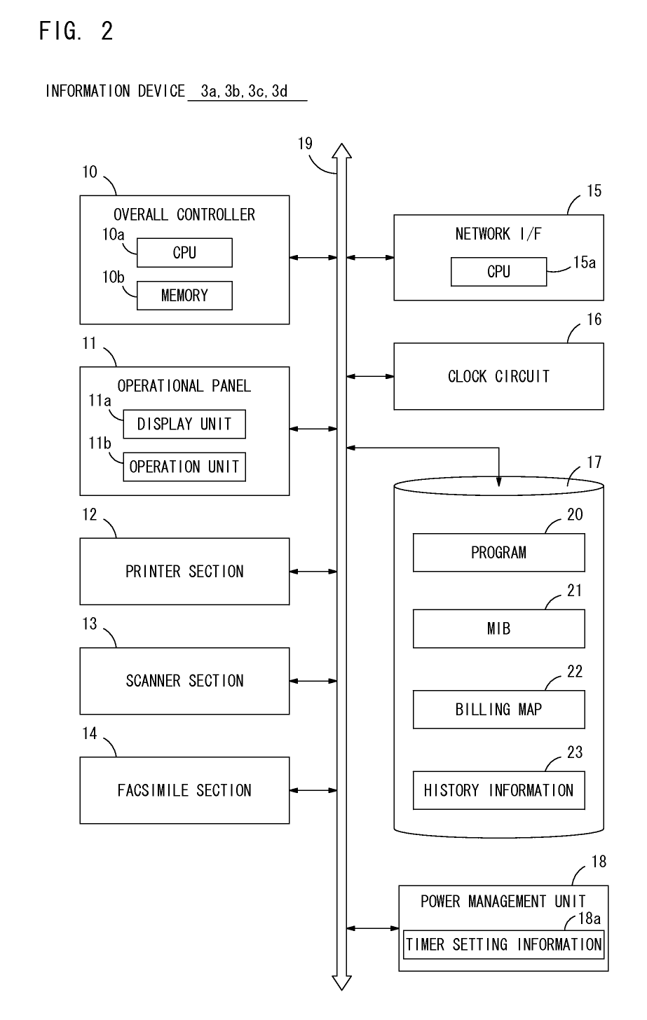

FIG. 2 is a block diagram showing the hardware configuration of the respective information devices 3a, 3b, 3c and 3d. Each of the information devices 3a, 3b, 3c and 3d is provided with an overall controller 10, an operational panel 11, a printer section 12, a scanner section 13, a facsimile section 14, a network interface 15, a clock circuit 16, a storage device 17 and a power management unit 18 that are connected to each other to allow data input and output between these parts through a data bus 19. Each of the plurality of information devices 3a, 3b, 3c and 3d of FIG. 2 has the same configuration, to which the present invention is not intended to be limited. Each device may have different configuration. More specifically, one or more of the plurality of information devices 3a, 3b, 3c and 3d could be a device without the scanner section 13 or the facsimile section 14.

The overall controller 10 including a CPU 10a and a memory 10b controls operation of each part. The CPU 10a reads and executes a program 20 installed in advance on the storage device 17, thereby performing various types of computation and controlling operation in the overall controller 10. The memory 10b stores therein data such as temporary data required in accordance with execution of the program 20 by the CPU 10a.

The operational panel 11 is a user interface for the users to operate each of the information devices 3a, 3b, 3c and 3d. The operational panel 11 is provided with a display unit 11a on which operation guide screens are displayed, and an operation unit 11b to which the users make variety of operations. Operation signals are output to the overall controller 10 in response to the user's operations.

The printer section 12 produces a printed output by forming an image on a sheet material such as a printing paper with xerographic, for example. The printer section 12 executes a print job specified by the overall controller 10, thereby producing the printed output.

The scanner section 13 generates image data by reading documents. The image data generated by reading documents is output to outside via the network interface 15 or stored in a certain storage region in the storage device 17. The scanner section 13 reads the documents in response to a scan job specified by the overall controller 10 and generates the image data.

The facsimile section 14 transmits and receives fax data through public phone lines which are not shown in FIG. 2. In response to receipt of the fax data, for example, the facsimile section 14 outputs the received fax data to the overall controller 10. For fax data transmission, the facsimile section 14 acquires the image data to transmit and transmits the fax data to an external address in response to a fax job specified by the overall controller 10.

The network interface 15 is responsible for connecting the information devices 3a, 3b, 3c and 3d to the network 4. Each information device 3a, 3b, 3c and 3d establishes data communication with the information processing device 1 and/or computer 2 connected through the network 4 via the network interface 15. The network interface 15 includes a CPU 15a. The CPU 15a determines whether or not data transmitted over the network 4 is addressed to itself and receives the data over the network 4 if it is addressed to itself. If, for example, the received data is a connectivity test command such as a ping command, the CPU 15a generates a response signal for the received connectivity test command and sends a response. As receiving the data other than the connectivity test command, the CPU 15a outputs the received data to the overall controller 10. The CPU 15a is also responsible for transmitting the data specified by the overall controller 10 over the network 4.

The clock circuit 16, called by a name such as a real time clock includes a function for ticking away the time and representing the current time in the respective information devices 3a, 3b, 3c and 3d. The clock circuit 16 is provided with an internal power supply which is not shown in FIG. 2. The power supplied through the internal power supply in the clock circuit 16 allows the clock circuit 16 to tick away the time and represent the current time even without the power supplied to each information device 3a, 3b, 3c and 3d from outside.

The storage device 17 is formed from a nonvolatile storage device such as a hard disk drive. The storage device 17 stores therein the program 20 executed by the CPU 10a of the overall controller 10 as described above. The storage device 17 also stores therein MIB (Management Information Base) 21, a billing map 22 and history information 23 besides the program 20. The MIB 21 is information to share the status of the respective information devices 3a, 3b, 3c and 3d with outside. The billing map 22 is to be referred to perform billing process in response to execution of the job to be charged in the respective information devices 3a, 3b, 3c and 3d. History of execution of the job in the respective information devices 3a, 3b, 3c and 3d is recorded as the history information 23.

Variety of information indicating the status of the respective information devices 3a, 3b, 3c and 3d are recorded as the MIB 21. The MIB 21 is accessed from outside via the network interface 15, so that the external device is allowed to refer to or to rewrite the information recorded as the MIB 21.

Unit price of each job, for example, is recorded as the billing map 22. The billing map 22 having the same unit prices set is stored in the respective information devices 3a, 3b, 3c and 3d. The unit prices are unified, so that the billing amount charged to the user for execution of the job with any of the plurality of information devices 3a, 3b, 3c and 3d may be the same.

Information as to the job executed in the respective information devices 3a, 3b, 3c and 3d is recorded as the history information 23. The information recorded as the history information 23 includes information of types of the executed job, a user who gave a job execution instruction, the job execution starting time, the job execution completion time and the billing amount calculated in response to execution of the job.

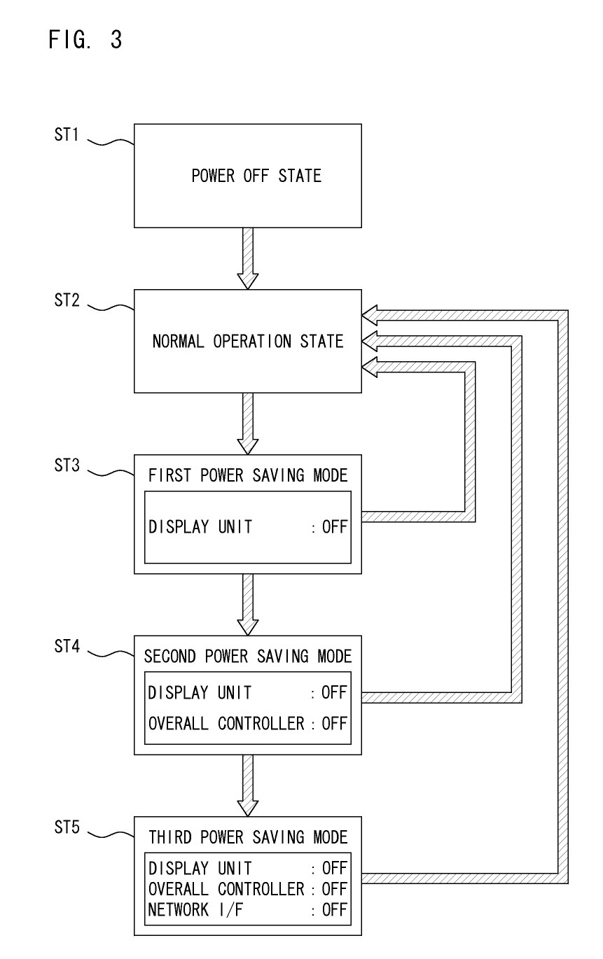

The power management unit 18 controls the status of power supplied to each of the above-described parts from external power not shown in FIG. 2. FIG. 3 shows the transition of the status of the power supply controlled by the power management unit 18.

In a power off state ST1, the power management unit 18 cuts electricity from external power and stop supplying power to each part. When the information device 3a, 3b, 3c or 3d is turned on by the user, for instance, the power management unit 18 starts supplying power to each part and places each part into a normal operation state ST2 from the power off state ST1. In the normal operation state ST2, power is normally supplied to each of the described-above parts and the job may be executed by putting the printer section 12, the scanner section 13 or the facsimile section 14 into operation by the overall controller 10.

The power management unit 18 includes a timer function to automatically start power supply to each part at turn-on time set in advance even when the information device 3a, 3b, 3c or 3d is not turned on by the user by manual. The power management unit 18 stores therein timer setting information 18a in which turn-on time is set. The power management unit 18 puts each part into the normal operation state ST2 from the power off state ST1 to allow execution of the job when the current time output by the clock circuit 16 represents the turn-on time set in advance.

The power management unit 18 is configured to monitor operation status of each part and place the power supply state into one of power saving modes when predetermined conditions are met. In FIG. 3, three power saving modes ST3, ST4 and ST5 are shown.

The first power saving mode ST3 is the first step of the power saving modes that each part in the normal operation state ST2 enters. When, for example, the operational panel 11 is not operated by the user while any job is not executed in the normal operation state ST2 and no data is received via the network interface 15 through the network 4 for more than a certain time, the power management unit 18 places the operation status into the first power saving mode ST3 from the normal operation state ST2. In the first power saving mode ST3, the power management unit 18 controls to turn off the display unit 11a of the operational panel 11. When the user operates the operational panel 11 or the data is received via the network interface 15 in the first power saving mode ST3, the power management unit 18 places the operational status in the first power saving mode ST3 back to the normal operation state ST2 to allow execution of the job.

After more than the certain time elapses without having data received via the network interface 15 while the operational panel 11 is not operated by the user in the first power saving mode ST3, the power management unit 18 places the operational status into the second step of the power saving modes, the second power saving mode ST4 from the first power saving mode ST3. In the second power saving mode ST4, the power management unit 18 controls to cut the power supplied to the overall controller 10 in addition to turning off the display unit 11a of the operational panel 11. As the user operates the operational panel 11 or the data is received via the network interface 15 in the second power saving mode ST4, the power management unit 18 places the operation status into the normal operation state ST2 from the second power saving mode ST4 to allow execution of the job.

The power management unit 18 does not always revert the operation status in the second power saving mode ST4 back to the normal operation state ST2 even with receipt of the data via the network interface 15 in the second power saving mode ST4. The second power saving mode ST4 is capable of reducing consumed electricity supplied to the information device in the first power saving mode ST3. In order to keep the second power saving mode ST4 uninterrupted as long as possible, the power management unit 18 does not revert the operation status back to the normal operation state ST2 if the less important data such as the connectivity test command is received via the network interface 15, for example. On the other hand, in response to receipt of the more important data such as the print job via the network interface 15, the power management unit 18 starts power supply to the overall controller 10 and reverts the operation status back to the normal operation state ST2. When the data is received via the network interface 15 in the second power saving mode ST4, the power management unit 18 reverts or does not revert the operation status back to the normal operation state ST2 depending on the type of the received data. What data makes the power management unit 18 revert the operation status back to the normal operation state ST2 from the second power saving mode ST4 when it is received via the network interface 15 may differ depending on the functions on each information device 3a, 3b, 3c and 3d or models of each information device 3a, 3b, 3c and 3d.

After more than the certain time elapses without having data received via the network interface 15 while the operational panel 11 is not operated by the user in the second power saving mode ST4, the power management unit 18 places the operation status in the second power saving mode ST4 into the third step of the power saving modes, the third power saving mode ST5. In the third power saving mode ST5, the power management unit 18 controls to cut the power supplied to the network interface 15 in addition to turning off the display unit 11a of the operational panel 11 and cutting power supply to the overall controller 10. In the third power saving mode ST5, the information device 3a, 3b, 3c or 3d is not allowed to receive data through the network 4. In response to the operation of the operational panel 11 in the third power saving mode ST5 by the user, however, the power management unit 18 reverts the operation status in the third power saving mode ST5 back to the normal operation state ST2 to allow execution of the job.

Thus, for example, in response to receipt of the instruction to change the settings in the normal operation state ST2 from the information processing device 1, the overall controller 10 changes the settings based on the instruction. The overall controller 10 is not allowed to change the settings based on the instruction from the information processing device 1 if each part is not in the normal operation state ST2. In order to change settings normally based on the instruction from the information processing device 1 by the overall controller 10, the power supply state is required to revert back to the normal operation state ST2 before receiving the settings change instruction from the information processing device 1.

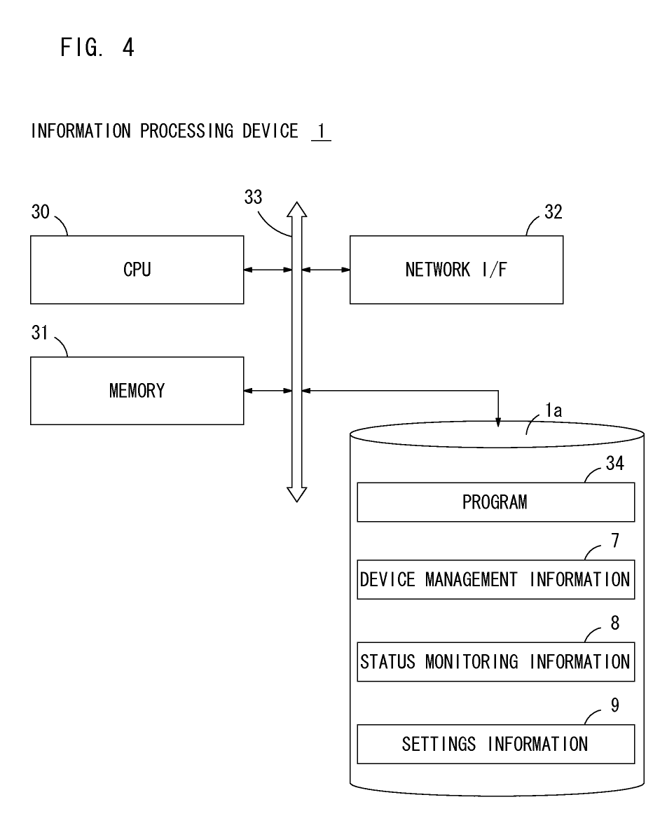

The information processing device 1 is explained next. FIG. 4 is a block diagram showing the hardware configuration of the information processing device 1. The information processing device 1 as shown in FIG. 4 includes a CPU 30, a memory 31, a network interface 32 and the storage device 1a that are connected to each other to allow data input and output between these parts through a data bus 33. The information processing device 1 may also be formed from a generally-used personal computer (PC), for example.

The storage device 1a stores therein a program 34 installed in advance on the information processing device 1 besides the device management information 7, the status monitoring information 8 and the settings information 9 as described above. The CPU 30 reads and executes the program 34 in the storage device 1a, thereby becoming operative to function as various types of parts explained later to change the settings for each information device 3a, 3b, 3c and 3d through the network 4. The memory 31 stores therein data such as temporary data required in accordance with execution of the program 34 by the CPU 30. The network interface 32 is responsible for connecting the information processing device 1 to the network 4. The CPU 30 establishes data communication with external devices via the network interface 32.

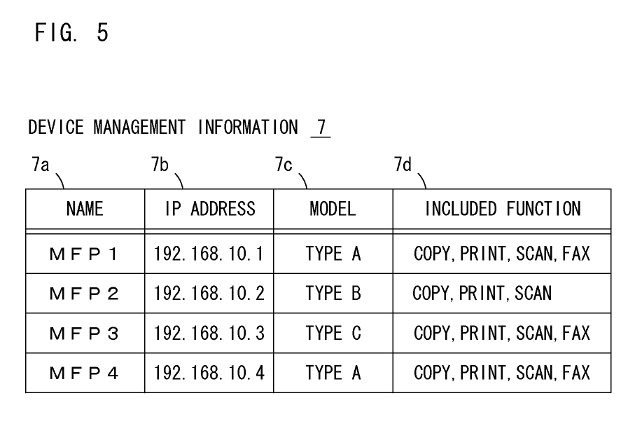

FIG. 5 shows an example of the device management information 7 stored in advance in the storage device 1a. Information as to each of the plurality of information devices 3a, 3b, 3c and 3d managed by the information processing device 1 is registered in the device management information 7 as shown in FIG. 5. To be more specific, information as to a name 7a, an IP address 7b, a model 7c and an included function 7d of each information device 3a, 3b, 3c and 3d is registered in the device management information 7.

The CPU 30 is allowed to obtain the information as to each managed information device 3a, 3b, 3c and 3d by referring to the device management information 7 as required in the information processing device 1. Some information devices without the above-mentioned timer function may be registered in the device management information 7 of FIG. 5. Those information devices may be identified as the model without the timer function with reference to the model 7c of the respective information devices. With reference to the included function 7d, it is identifiable that whether or not the each information device 3a, 3b, 3c and 3d registered in the device management information 7 includes the print function or the facsimile function. Thus, when becoming operative to function as the various types of parts explained later, the CPU 30 refers to the device management information 7 of FIG. 5 as required, thereby determining what functions are included in each of the managed information devices 3a, 3b, 3c and 3d.

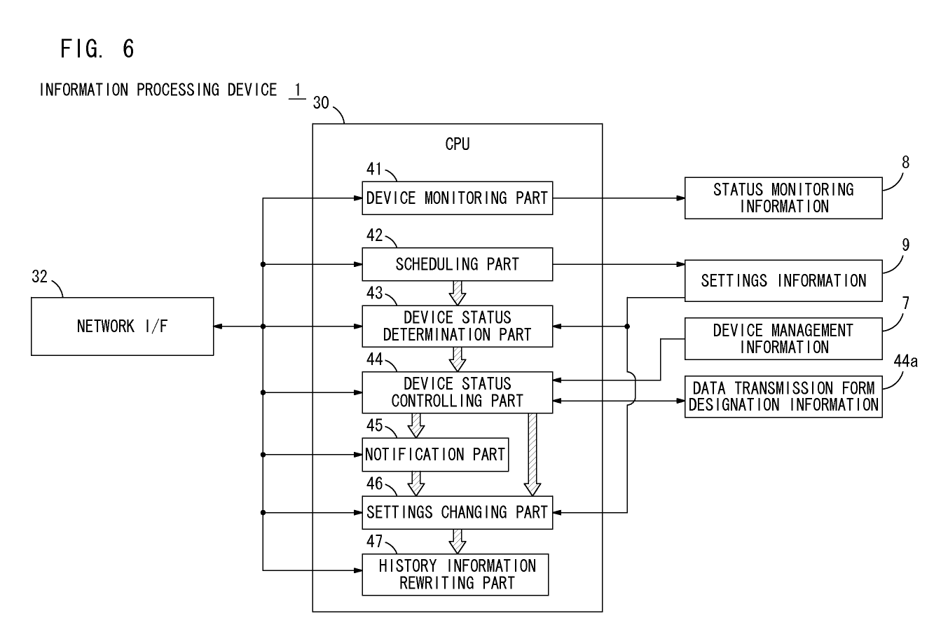

FIG. 6 is a block diagram showing the functional configuration realized by execution of the program 34 by the CPU 30. As illustrated in FIG. 6, the CPU 30, with execution of the program 34, functions as a device monitoring part 41, a scheduling part 42, a device status determination part 43, a device status controlling part 44, a notification part 45, a settings changing part 46 and a history information rewriting part 47.

The device monitoring part 41 monitors the operation status of each information device 3a, 3b, 3c and 3d by, for example, polling the status periodically to each of the plurality of information devices 3a, 3b, 3c and 3d registered in the device management information 7. The interval to poll the status via the network interface 32 by the device monitoring part 41 is configured to be, for example, an hour. The intervals, however, may be longer or shorter than an hour. The device monitoring part 41 becomes operative to function in the CPU 30 every hour and polls the status to the plurality of information devices 3a, 3b, 3c and 3d. The device monitoring part 41 then determines that the information device gave the response in response to the polling is in an operation state. The device monitoring part 41 determines that the information device did not give the response in response to the polling is in periods when the device is unavailable (hereafter, in a sleeping state). The device monitoring part 41 records the determination result of the operation status of each information device 3a, 3b, 3c and 3d as the status monitoring information 8. The status monitoring information 8 thereby recorded includes date and time when the status is polled.

The status monitoring information 8 is information in which the operation status of each information device 3a, 3b, 3c and 3d monitored periodically by the device monitoring part 41 as described above is accumulated as logs. More specifically, whether each information device 3a, 3b, 3c and 3d is in the operation state or in the sleeping state is recorded hourly, for example, as the status monitoring information 8. With the status monitoring information 8, from and to what time each information device 3a, 3b, 3c and 3d used to be in the operation state normally is predicable.

The above-described device monitoring part 41 becomes operative to function regularly in the CPU 30 regardless of the schedule of the change of the settings for the plurality of information devices 3a, 3b, 3c and 3d. In contrast, the scheduling part 42, the device status determination part 43, the device status controlling part 44, the notification part 45, the settings changing part 46 and the history information rewriting part 47 become operative to function when the change of the settings for the plurality of information devices 3a, 3b, 3c and 3d is scheduled. The scheduling part 42, the device status determination part 43, the device status controlling part 44, the notification part 45, the settings changing part 46 and the history information rewriting part 47 are explained next.

The scheduling part 42 configures the schedule of the change of the settings for the plurality of information devices 3a, 3b, 3c and 3d. The scheduling part 42 is put into operation in response to the instruction to collectively change the settings for the plurality of information devices 3a, 3b, 3c and 3d by the administrator received via the network interface 32 by the CPU 30, for instance. The scheduling part 42 schedules the collective settings change in response to the instruction and registers the settings information 9 in the storage device 1a.

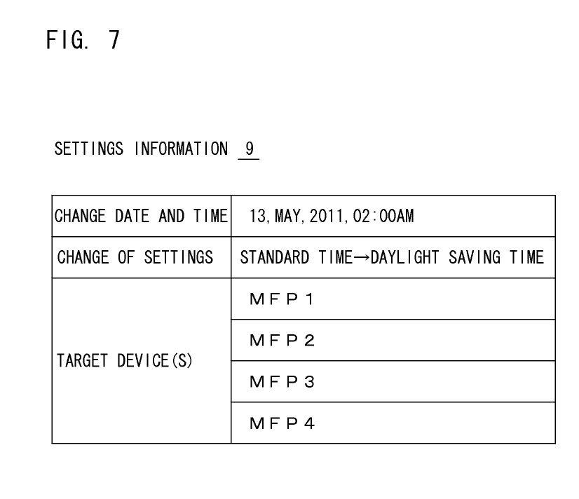

FIG. 7 shows an example of the settings information 9 registered by the scheduling part 42. As shown in FIG. 7, the settings information 9 includes scheduled date and time to change the settings collectively (hereafter, change date and time), the change of the settings that specifically designates what to change in the settings for the collective settings change and the targeted devices that the settings for which are to be changed at the collective settings change. The scheduling part 42 generates the settings information 9 of FIG. 7 based on the information in the received instruction and registers in the storage device 1a. In accordance with the settings information 9 of FIG. 7, time of the clock circuit 16 in the respective plurality of information devices 3a, 3b, 3c and 3d is configured to collectively set ahead or turn back for daylight saving time from standard time on the change date and time. The change of the settings for the collective settings change is not just adjusting the time of the clock circuit 16 for daylight saving time from standard time on the change date and time as described in FIG. 7. It may be configured to adjust the time of the clock circuit 16 for standard time from daylight saving time. Or, it may be configured to update the billing map 22 in the respective plurality of information devices 3a, 3b, 3c and 3d. Further, other settings for the respective plurality of information devices 3a, 3b, 3c and 3d may be changed.

The scheduling part 42 registers the change date and time specified by the collective settings change instruction in the settings information 9. The scheduling part 42 registers in the settings information 9 only if preparation period that is at least more than 24 hours to the specified change date and time can be secured. It is preferable to secure more than one week as for the preparation period. When less than 24 hours is left to the change date and time at time of the registration in the settings information 9, the scheduling part 42, for example, sends a message to notify the administrator of reschedule of the change date and time. The preparation period at least more than 24 hours to the specified change date and time, therefore, can be secured. When it is scheduled to change collectively the settings for the plurality of information devices 3a, 3b, 3c and 3d by the scheduling part 42, the preparation time that is at least more than 24 hours is secured before the collective settings change is performed.

The settings change may include adjusting the time of the clock circuit 16 for daylight saving time or for standard time besides updating the data of the billing map 22. For those settings changes, the scheduling part 42 is capable of registering automatically in the settings information 9 based on information such as regions where the information processing device 1 is located even without the instruction by the administrator. The scheduling part 42 does not always register the settings information 9 in response to the instruction by the administrator. The scheduling part 42 may automatically register the settings information 9. In such a case, the preparation period before the change date and time for the collective settings change is preferably secured more than a week.

As the collective settings change is scheduled as described above, the device status determination part 43 in the CPU 30 is put into operation next. The device status determination part 43 is put into operation during the above-explained preparation period. The device status determination part 43 determines if each of the plurality of information devices 3a, 3b, 3c and 3d, the target device for the settings change, is ready for settings change at the same time as the change time on the day before the change date scheduled for the collective settings change. If more than a week is left for the preparation period, for example, the device status determination part 43 determines if each of the plurality of information devices 3a, 3b, 3c and 3d, the settings for which is ready to be changed at the same time on the same day as the change date and time scheduled for the collective settings change. If less than a week is left for the preparation period, for example, the device status determination part 43 determines whether or not each of the plurality of information devices 3a, 3b, 3c and 3d, the settings for which is ready to be changed at the same time as the change time on the day before the change date scheduled for the collective settings change.

The device status determination part 43 performs the process explained below to determine if each of the plurality of information devices 3a, 3b, 3c and 3d is ready for the settings change. The device status determination part 43 transmits the connectivity test command such as the ping command to each of the plurality of information devices 3a, 3b, 3c and 3d. After receiving the response signal in response to the connectivity test command, the device status determination part 43 determines if the information device from which the response signal is received is ready for the settings change. The device status determination part 43 rewrites information which does not specifically affect the use of the information device (for example, information in which a nickname for the information device is registered) and determines if the operation to rewrite the information is actually reflected to the information device. To be more specific, the device status determination part 43 tests the information device from which the response signal is received for tentative change which is different from the change to be made in the collective settings change.

When the tentative change is made normally in the information device, the device status determination part 43 determines that the information device is ready for the settings change. When the tentative change is not made normally in the information device, the device status determination part 43 determines that the information device is not ready for the settings change.

If there is the information device which does not send the response signal in response to the connectivity test command transmitted at first, the device status determination part 43 determines that the information device is not ready for the settings change without testing the information device for the tentative change.

Thus, whether or not each of the plurality of information devices 3a, 3b, 3c and 3d is ready for settings change is determined at the same time as the change time on the day before the change date and time scheduled for the collective settings change. With the determination, the status of each of the plurality of information devices 3a, 3b, 3c and 3d on the change date and time scheduled for the collective settings change may be checked in advance. If the information device which is not ready for the settings change is identified as a result of the determination by the device status determination part 43, the device status controlling part 44 is put into operation next in the CPU 30.

If it is determined that one or more of the plurality of information devices 3a, 3b, 3c and 3d are not ready for the settings change by the device status determination part 43, the device status controlling part 44 controls to make the information device not ready for the settings change become ready for the settings change on the date and time scheduled for the collective settings change.

The device status controlling part 44 is put into operation soon after the determination is complete by the device status determination part 43 and transmits data to the information device determined to be not ready for the settings change by the device status determination part 43. The device status controlling part 44 is configured to transmit the data in variety of forms. The device status controlling part 44 transmits, for example, a wake-up signal, information to rewrite the information of MIB 21, the print job or the fax data to the information device not ready for the settings change. The information device not ready for the settings change may become ready for the settings change by receiving such data. The device status controlling part 44 determines whether or not the information device has become ready for the settings change through data transmission every time it transmits the data in the different form. When determining that the information device became ready for the settings change, the device status controlling part 44 records the data transmission form as data transmission form designation information 44a.

The device status controlling part 44 designates in advance the data transmission form which allows the information device not ready for the settings change becoming ready for the settings change before the date and time scheduled for the collective settings change and records the designated data transmission form as the data transmission form designation information 44a. The data transmission form thereby designated includes a data type or a communication protocol type. The data transmission form designation information 44a is information in which the designated data transmission form and the information device are associated with each other one by one. The data transmission form designation information 44a is stored in the certain storage region in the storage device 1a, for instance.

The device status controlling part 44 is put into operation again on the date and time scheduled for the collective settings change. The device status controlling part 44 then reads the data transmission form designation information 44a. The device status controlling part 44 transmits the data in the form designated in advance to the information device recorded in the data transmission form designation information 44a. The device status controlling part 44 transmits, for example, data in the form designated in advance to the information device which is any of the wake-up signal, the information to rewrite the information of MIB 21, the print job and the fax data. The information device not ready for the settings change is allowed to be ready for the settings change at the time of the collective settings change.

The device status controlling part 44 transmits the data in a predetermined several ways to the information device determined by the device status determination part 43 to be not ready for the settings change to designate the data transmission form as described above. In some cases, the information device does not become ready for the settings change even with the data transmission in the predetermined several ways. The device status controlling part 44 then refers to the device management information 7 to determine if the information device is the model which includes the timer function. For the information device including the timer function, the device status controlling part 44 accesses the timer setting information 18a and adds the change date and time as the turn-on time recorded in the timer setting information 18a.

For the information device, for example, in the power off state ST1 or the third power saving mode ST5, the device status controlling part 44 is not allowed to normally add the turn-on time as described above. In such a case, the device status controlling part 44 may refer to the status monitoring information 8 to identify from and to what time the information device being operative and adds the turn-on time at the identified time.

The device status controlling part 44 configures in advance the change date and time as the turn-on time and records as the timer setting information 18a of the information device. The information device, therefore, is allowed to enter the normal operation state ST2 at the time of the collective settings change and become ready for the settings change.

The device status controlling part 44 may not cause the information device turning on automatically on the change date and time if the information device determined by the device status determination part 43 to be not ready for the settings change does not include the timer function. The notification part 45 becomes operative to function in the CPU 30 then.

The notification part 45 is put into operation when the device status controlling part 44 cannot make the information device not ready for the settings change become ready for the settings change. The notification part 45 notifies in advance the predetermined user such as the administrator to turn on the information device determined by the device status determination part 43 to be not ready for the settings change on the change date and time. The notification part 45 notifies the user by sending an e-mail, for example. The notification part 45 notifies the predetermined user before the change date and time, so that the notified user turns on the specified information device on the change date and time by manual. As a result, the information device becomes ready for the settings change at the time of the collective settings change.

The settings changing part 46 is put into operation on the change date and time registered in the settings information 9. The settings changing part 46 changes collectively the settings for the plurality of information devices 3a, 3b, 3c and 3d, the target devices for the settings change, according to the settings information 9 on the change date and time.

For configuring the time of the clock circuit 16 of the respective information devices 3a, 3b, 3c and 3d to adjust for daylight saving time from standard time or otherwise, the settings changing part 46 sends a control signal to set ahead or turn back a certain time (for instance, an hour) from the current time. Each information device 3a, 3b, 3c and 3d receives the control signal configures the time of the clock circuit 16 to adjust for daylight saving time from standard time or to standard time from daylight saving time.

For updating the billing map 22 in the respective information devices 3a, 3b, 3c and 3d, the settings changing part 46 gives an instruction to update the billing map 22 to each information device 3a, 3b, 3c and 3d while transmitting new data of the billing map 22. Each information device 3a, 3b, 3c and 3d thereby received the new data updates the billing map 22 stored therein. The same process is performed when other data is to be changed.

Even one or more of the plurality of information devices 3a, 3b, 3c and 3d are not ready for the settings change just before the settings change, the device status controlling part 44 controls to make the information device not ready for the settings change become ready for the settings change at the settings change. The settings changing part 46, therefore, is capable of collectively changing the settings for the larger number of the information devices compared to the conventional information processing devices.

The settings changing part 46 changes the settings collectively on the change date and time, but there may be the information device, the settings for which failed to be changed then. This may be caused by, for example, the user who is notified in advance to turn on the designated information device by the notification part 45 forgetting to turn on by manual. The settings changing part 46 specifies the information device, the settings for which failed to be changed at the collective settings change on the change date and time. Further, the settings changing part 46 reads the status monitoring information 8 and predicts the time when the specified information device becomes operative after the change date and time. The settings changing part 46 retries to change the settings for the information device, the settings for which is failed to be changed at the collective settings change at the predicted time.

When there are one or more of the information devices, the settings for which are failed to be changed collectively on the change date and time, the settings changing part 46 retries to change the settings at the time when the information device becomes operative after the change date and time. The settings change is allowed to be made at the time when the information device in the sleeping state becomes operative. Thus, the settings changing part 46 can make the settings change before the information device, the settings for which failed to be changed collectively on the change date and time is used by the user.

The information recorded as the status monitoring information 8 is that as to the operation status of each information device 3a, 3b, 3c and 3d obtained, for example, every hour by the device monitoring part 41 as described above. It is assumed that the information showing that the information device, the settings for which failed to be changed collectively on the change date and time becomes operative at 7 am is recorded as the status monitoring information 8. Even with the information, it is possible to have the information device actually become operative at 6:30 am. So, in such a case, when predicting that the information device next becomes operative at 7 am based on the status monitoring information 8, the settings changing part 46 makes ready for the information device to become operative from a predetermined time before the predicted time. To be more specific, the settings changing part 46 polls the status every relatively short period of time (such as, one minute) to the information device the predetermined time (such as, one hour) before the predicted time. It is preferable to configure the settings changing part 46 to determine that the information device becomes operative at receipt of the response to polling the status and to change the settings. Thus, the settings changing part 46 is allowed to immediately change the settings when the information device, the settings for which failed to be changed collectively on the change date and time is determined to become operative.

The settings changing part 46 tries to change the settings for the information device, the settings for which failed to be changed collectively on the change date and time again after the failure. It is possible that the users have already used the information device by the completion of the settings change on the second try. Then, the information relating to the job executed after the change date and time has been recorded as the history information 23 in the information device. For the information device, the settings for which is tried again to change after the change date and time, the settings changing part 46 reads the history information 23 stored in the information device to determine if any history is recorded after the change date and time. When there is the history recorded after the change date and time, the settings changing part 46 puts the history information rewriting part 47 into operation next.

The history information rewriting part 47 rewrites the history information 23 recorded between the change date and time and the completion of the settings change after the settings change is complete by the settings changing part 46. It is assumed for example that the time of the time circuit 16 is changed by the settings changing part 46. In such a case, the history information rewriting part 47 rewrites job execution starting time or job execution completing time recorded as the history information 23 after the change date and time to the time to which the settings change is applied. It is further assumed that the billing map 22 is changed by the settings changing part 46. In such a case, the history information rewriting part 47 rewrites the billing amount charged after the change date and time and recorded as the information history 23 to the amount that is calculated based on the billing map to which the settings change is applied. The history information rewriting part 47, therefore, rewrites the history information 23 in the information device, thereby modifying the incorrect information recorded after the change date and time to the correct information.

According to the present preferred embodiment, the information device predicted not to be ready for the settings change on the change date and time is controlled to become ready for the settings change just before the change date and time as described above. Regarding to the information device, the settings for which is failed to be changed on the change date and time, the settings for the information device is changed at the time when the information device becomes operative after the failure. It is not often that the information device to which the settings change is yet to be applied is used by the user after the change date and time. In most of the cases, the process to change the settings for the plurality of information devices 3a, 3b, 3c and 3d is complete without rewriting of the history information 23 by the history information rewriting part 47.

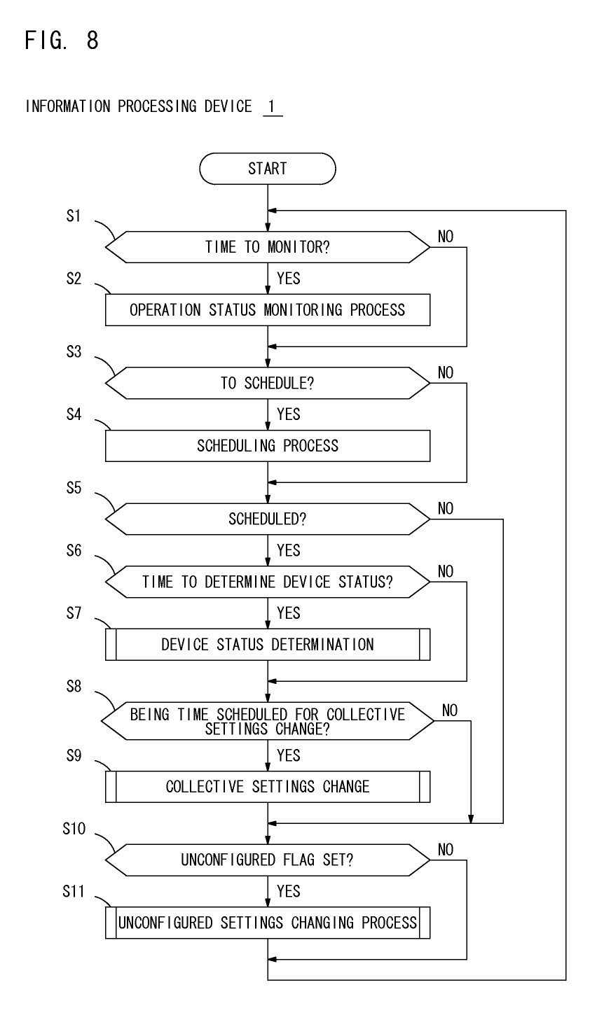

Next, detailed operation of the information processing device 1 as described above is explained. FIGS. 8 to 11 are flow diagrams explaining exemplary sequential procedures of processes performed by the CPU 30 in the information processing device 1. The processes are performed in response to execution of the program 34 by the CPU 30 after the information processing device 1 being turned on.

Upon start of this process as shown in FIG. 8, the information processing device 1 determines if it is the time for the device monitoring part 41 to monitor (step S1). If it is the time to monitor (when a result of step S1 is YES), the information processing device 1 puts the above-described device monitoring part 41 into operation to perform the operation status monitoring process (step S2). In the process, the information processing device 1 monitors the operation status of each information device 3a, 3b, 3c and 3d by periodically polling the status to each of the plurality of information devices 3a, 3b, 3c and 3d registered in the device management information 7. The information processing device 1 then records the results as the status monitoring information 8. The operation status monitoring process is performed at regular time intervals such as an hour as explained above. When the certain time has not elapsed since the previous operation status monitoring process is performed (when a result of step S1 is NO), this operation status monitoring process (step S2) is not performed.

The information processing device 1 determines whether or not to schedule the collective settings change (step S3). The result of step S3 is determined as YES when the instruction to collectively change the settings by the administrator is received from the computer 2, for instance. In such a case, the information processing device 1 performs the scheduling process (step S4). The information processing device 1 generates the settings information 9 in which the schedule of the collective settings change is registered in response to the instruction to collectively change the settings from the computer 2 and stores the generated information in the storage device 1a. When the collective settings change is not newly scheduled in step S3 (when a result of step S3 is NO), the scheduling process (step S4) is not performed.

The information processing device 1 determines whether or not the collective settings change is scheduled (step S5). The information processing device 1 determines by checking whether or not the scheduled collective settings change yet to be made is registered as the settings information 9 in the storage device 1a.

As the collective settings change is scheduled (when a result of step S5 is YES), the information processing device 1 determines whether or not it is the time for the device status determination part 43 to determine the device status (step S6). It is determined if it is the same time as the change time on the day before the change date registered as the settings information 9. If it is the same time as the change time which is the time to determine the device status (when a result of step S6 is YES), the information processing device 1 performs the device status determination (step S7). If it is not the time to determine the device status (when a result of step S6 is NO), the device status determination (step S7) is skipped.

As the collective settings change is scheduled (when a result of step S5 is YES), the information processing device 1 determines if it is the time scheduled for the collective settings change by the settings changing part 46 (step S8). The information processing device 1 determines if it is the change date and time registered as the settings information 9 in this step. If the current time is the change date and time registered as the settings information 9 (when a result of step S8 is YES), the information processing device 1 performs the collective settings change (step S9). If it is not the time for the collective settings change (when a result of step S8 is NO), the information processing device 1 skips the collective settings change (step S9).

When it is determined that the collective settings change is not scheduled in step S5 (when a result of step S5 is NO), the process in step S6 to S9 is skipped.

The information processing device 1 determines whether or not an unconfigured flag is set (step S10). The unconfigured flag is a flag that is set when there is the information device, the settings for which is failed to be changed in the collective settings change. With the unconfigured flag set (when a result of step S10 is YES), the information processing device 1 performs the unconfigured settings changing process (step S11). When the unconfigured flag is not set (when a result of step S10 is NO), the information processing device 1 skips the unconfigured settings changing process (step S11). The process performed by the information processing device 1 returns to step S1 as illustrated in FIG. 8 and the process as described above is repeatedly performed.

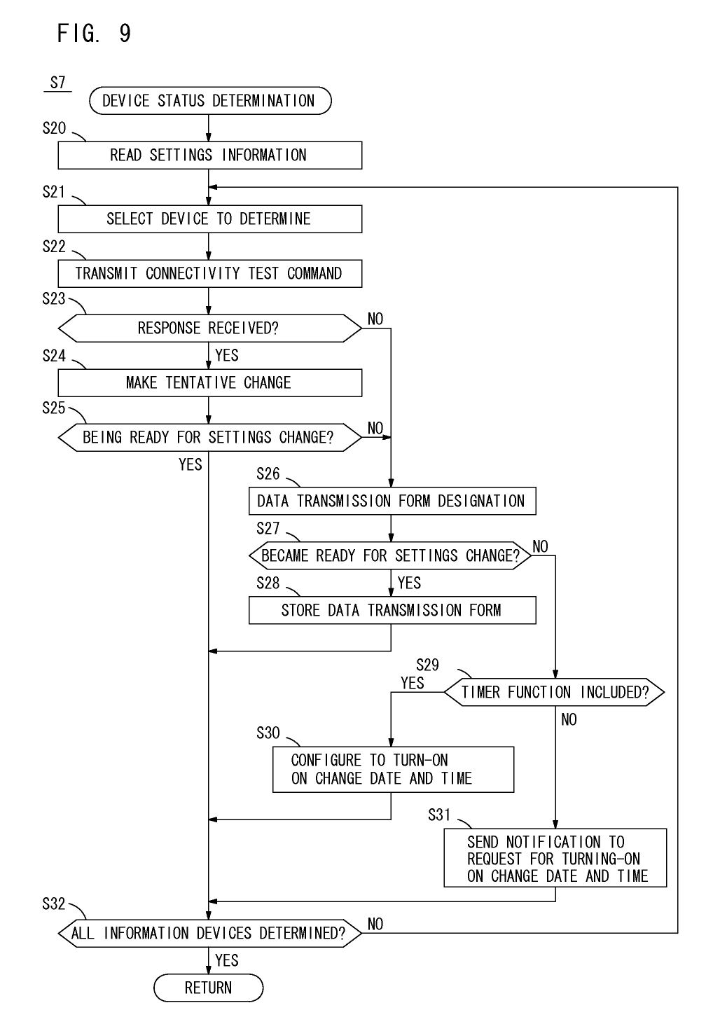

FIG. 9 is a flow diagram explaining in detail an exemplary process sequence of the device status determination (step S7). After starting the process, the information processing device 1 reads the settings information 9 in the storage device 1a (step S20). The information processing device 1 selects the information device to determine from among the target devices registered in the settings information 9 (step S21) and transmits the connectivity test command to the selected information device (step S22). The information processing device 1 then determines whether or not any response is received from the information device to which the connectivity test command is transmitted (step S23). After receiving the response (when a result of step S23 is YES), the information processing device 1 makes the tentative change on the settings for the information device. For the tentative change, the information such as the nick name of the information device is changed, for example. As the tentative change is complete normally on the settings for the information device, the changed information such as the nick name is restored to the original.

The information processing device 1 determines whether or not the information device is ready for the settings change (step S25). When the tentative change is made normally on the settings for the information device, the information device is determined to be ready for the settings change, whereas determined to be not ready for the settings change when the tentative change is failed to be made normally. As the information device is determined to be ready for the settings change (when a result of step S25 is YES), the process in step S32 is performed next.

As not receiving the response in response to the connectivity test command (when a result of step S23 is NO), or as the information device sending the response to the connectivity test command is determined to be not ready for the settings change (when a result of step S25 is NO), the information processing device 1 performs the data transmission form designation (step S26). In the data transmission form designation, the information processing device 1 confirms if the information device is placed into the state ready for the settings change from that not ready for the settings change by trying data transmission in the various types of data transmission forms to the information device. After the data transmission form designation (step S26), the information processing device 1 determines whether or not the information device is become ready for the settings change (step S27).

After the information device became ready for the settings change through the data transmission form designation (when a result of step S27 is YES), the information processing device 1 designates the data transmission form that makes the information device become ready for the settings change and stores the designated data transmission form (step S28). After step S28, the information processing device 1 moves on to step S32.

When the information device does not become ready for the settings change even with the data transmission form designation (when a result of step S27 is NO), the information processing device 1, for example, refers to the device management information 7 to determine whether or not the information device includes the timer function (step S29). For the information device including the timer function (when a result of step S29 is YES), the information processing device 1 additionally sets the change date and time scheduled for the collective settings change as the turn-on time recorded in the timer setting information 18a of the information device, thereby configuring the information device to turn on automatically on the change date and time (step S30). After step S30, the information processing device 1 performs the process in step S32 next. The process in step S30 may be performed at times when the information device is operating and prior to the change date and time.

As the information device not ready for the settings change does not include the timer function (when a result of step S29 is NO), the information processing device 1 sends the notification to request for turning on the information device on the change date and time to the predetermined user such as the administrator, for example (step S31). The process moves on to step S32.

The information processing device 1 determines whether or not all the above-described process in step S21 to S31 has been performed for every target device registered in the settings information 9 (step S32). If there is any information device that has not been determined, the information processing device 1 returns to step S21 to repeatedly perform the above-explained process. After all of the information devices are determined (when a result of step S32 is YES), the device status determination (step S7) is complete.

The information processing device 1 performs the above-explained device status determination (step S7) prior to the change date and time. The information processing device 1, therefore, is allowed to make the information device registered as the target device in the settings information 9 become ready for the settings change on the change date and time.

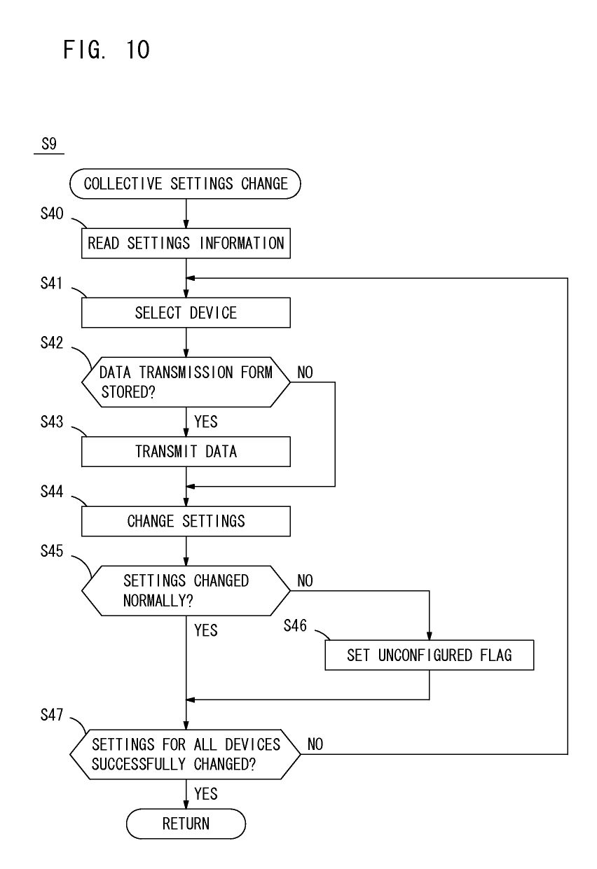

FIG. 10 is a flow diagram explaining in detail an exemplary process sequence of the collective settings change (step S9). The information processing device 1 starts the collective settings change on the change date and time. Upon the start, the information processing device 1 reads the settings information 9 in the storage device 1a (step S40) and selects the information device to change the settings for which from among the target devices registered in the read settings information 9 (step S41). The information processing device 1 checks to see if the designated data transmission form capable of realizing the state in which the information device being ready for the settings change is stored for the selected information device (step S42). With the data transmission form (when a result of step S42 is YES), the information processing device 1 transmits the data in the designated form to the selected information device (step S43). As a result, the selected information device not ready for the settings change is allowed to become ready for the settings change by receiving the data from the information processing device 1. The process in step S43 is skipped with no data transmission form being set in association with the selected information device.

The information processing device 1 then changes the settings for the selected information device according to the settings change registered in the settings information 9 (step S44). The settings change includes, for example, changing the time of the clock circuit 16, updating the data of the billing map 22 or changing the other settings. After changing the settings, the information processing device 1 determines if the settings are changed normally (step S45). When the settings is failed to be changed normally (when a result of step S45 is NO), the information processing device 1 sets the unconfigured flag on the information device (step S46). When the settings is changed normally (when a result of step S45 is YES), the information processing device 1 does not set any unconfigured flag.

The information processing device 1 checks to see if the above-explained process in step S41 to S46 is performed for all of the target devices registered in the settings information 9 (step S47). The information processing device 1 repeatedly performs the process by returning to step S41 for the information device for which the above-explained process yet to be performed. With the settings for all of the information devices successfully changed (when a result of step S47 is YES), the collective settings change (step S9) is complete.

The information processing device 1 is capable of making the same change on the settings for each of the plurality of information devices 3a, 3b, 3c and 3d registered as the target devices in the settings information 9 almost at the same time on the change date and time through the above-described collective settings change (step S9).

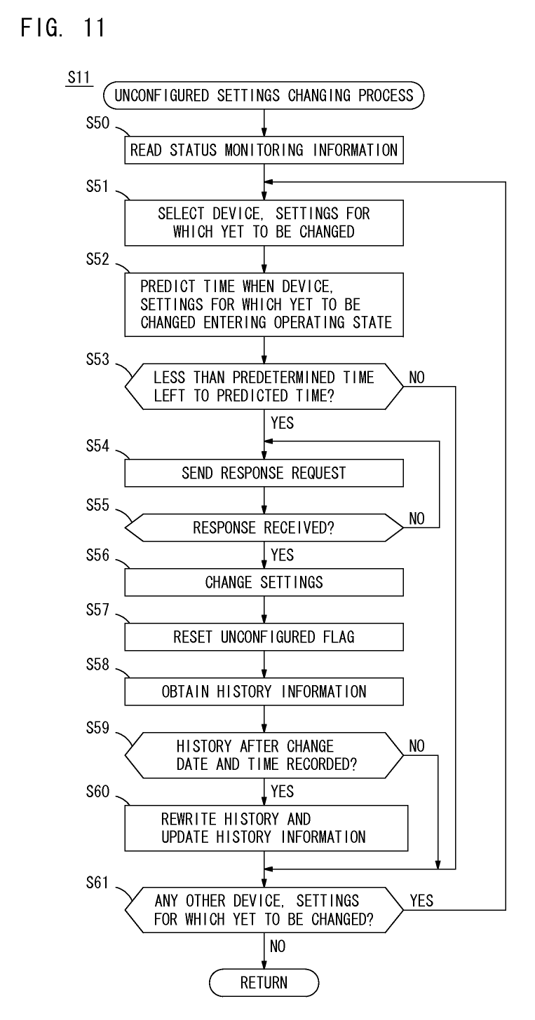

FIG. 11 is a flow diagram explaining in detail an exemplary process sequence of the unconfigured settings changing process (step S11). With the unconfigured flag set, the information processing device 1 starts this process. Upon the start, the information processing device 1 reads the status monitoring information 8 (step S50). The information processing device 1 selects the information device, the settings for which is yet to be changed in the collective settings change (step S51). The information processing device 1 refers to the status monitoring information 8 corresponds to the selected information device and predicts the time when the information device enters the operating state (the normal operation state ST2) next (step S52). The information processing device 1 obtains the current time and determines whether or not less than the predetermined time is left to the predicted time (step S53).

As the result of the determination, less than the predetermined time is left to the predicted time when the information device enters the operating state (when a result of step S53 is YES). In such a case, the information processing device 1 sends the response request, for example, polling the status to the information device (step S54). The information processing device 1 determines if the response is received from the information device (step S55). When not receiving the response, the information processing device 1 repeatedly sends the response request. By repeatedly sending the response request, the information processing device 1 is allowed to receive the response from the information device at the time when the information device becomes operative. In response to the receipt of the response from the information device (when a result of step S55 is YES), the information processing device 1 changes the settings for the information device (step S56). The information processing device 1 then resets the unconfigured flag set on the selected information device (step S57).

The information processing device 1 obtains the history information 23 in the information device, the settings for which is changed (step S58). The information processing device 1 checks if any history after the change date and time is recorded (step S59). When there is the history recorded as the history information 23 after the change date and time (when a result of step S59 is YES), the information processing device 1 rewrites the history to match the change made to the settings and updates the history information 23 (step S60). When there is no history recorded as the history information 23 after the change date and time (when a result of step S59 is NO), the process in step S60 is skipped.

More than the predetermined time is left to the predicted time when the information device, the settings for which is yet to be changed becomes operative (when a result of step S53 is NO). In such a case, the process in step S54 to S60 is skipped.

The information processing device 1 determines if there is any other information device on which the unconfigured flag is set (step S61). If there is any other information device, the information processing device 1 returns to step S51 to perform the above-described process repeatedly. If there is no other information device, the unconfigured settings changing process (step S11) is complete.

The above-explained unconfigured settings changing process (step S11) allows the information processing device 1 to change the settings for the information device, the settings for which is failed to be changed at the collective settings change performed on the change date and time.

The information processing device 1 of the present preferred embodiment and the plurality of information devices 3a, 3b, 3c and 3d are connected together through the network 4. The information processing device 1 configures the change date and time to change the settings for every information device 3a, 3b, 3c and 3d. The information processing device 1 then determines whether or not each of the plurality of information devices 3a, 3b, 3c and 3d is ready for the settings change at the same time as the change time on the day before the change date. When one or more of the plurality of information devices 3a, 3b, 3c and 3d are determined to be not ready for the settings change, the information device not ready for the settings change is caused to become ready for the settings change on the change date and time.

The information processing device 1 is allowed to change collectively the settings for each information device 3a, 3b, 3c and 3d that has become ready for the settings change on the change date and time scheduled to change collectively the settings for the plurality of information devices 3a, 3b, 3c and 3d. More specifically in the present preferred embodiment, even when each information device 3a, 3b, 3c and 3d is in the power off state ST1 or one of the power saving modes ST3, ST4 and ST5 just before the change date and time, such information device may be reverted back to the normal operation state ST2, so that the settings for the information device is allowed to be changed at the collective settings change. The information processing device 1 of the present preferred embodiment is capable of reducing the occurrence of the information device, the settings for which is failed to be changed at the time when the settings for the plurality of information devices 3a, 3b, 3c and 3d are changed collectively.

The above-explained device status controlling part 44 of the present preferred embodiment transmits data to the information device not ready for the settings change at least once when it is determined by the device status determination part 43 that the information device is not ready for the settings change. Through at least one data transmission, the device status controlling part 44 designates in advance the data transmission form that makes the information device not ready for the settings change become ready for the settings change. The device status controlling part 44 transmits the data in the form designated in advance to the information device not ready for the settings change, thereby making the information device not ready for the settings change become ready for the settings change on the change date and time. The plurality of information devices 3a, 3b, 3c and 3d are caused to become ready for the settings change at time of the collective settings change.

The information device determined by the device status determination part 43 not to be ready for the settings change may include the timer function. For such information device, the device status controlling part 44 of the present preferred embodiment configures the information device to turn on automatically on the change date and time with the timer function. Each of the plurality of information devices 3a, 3b, 3c and 3d is turned on automatically to be ready for the settings change at time of the collective settings change. With reference to the status monitoring information 8, the time when the information device becomes ready for the settings change prior to the change date and time is identified in the case where the information device is configured to turn on automatically with the timer function. The information device may be configured at the identified time to turn on automatically on the change date and time. So, the information device may be certain to turn on automatically on the change date and time

The device status controlling part 44 configures the information device to turn on automatically on the change date and time as described above. In such a case, the information device automatically turned on is preferably turned off in response to completion of the settings change. This configuration may prevent the power kept being supplied to the information device during hours when that is not used by the users even after the settings for the information device is changed.

When there is one or more of the information devices 3a, 3b, 3c or 3d, the settings for which are failed to be changed on the change date and time, the above-explained settings changing part 46 of the present preferred embodiment refers to the status monitoring information 8 to identify the time when the information device, the settings for which is failed to be changed becomes ready for the settings change and changes the settings when the information device becomes ready for the settings change. Even with the information device, the settings for which is failed to be changed collectively on the change date and time, the settings for the information device is allowed to be changed immediately as the information device becomes ready for the settings change after the failure.

The information processing device 1 of the present preferred embodiment includes the history information rewriting part 47 rewriting the history information 23 recorded between the change date and time and the time of completion of the settings change when the settings are changed by the settings changing part 46. It is assumed that the information device has been used by the user between the change date and time and the time of completion of the settings change. Even in such a case, the information to which the settings change is not applied may be prevented from being recorded as the history information 23 since the history information 23 already recorded in the information device may be rewritten.

The information processing device 1 of the present preferred embodiment notifies the predetermined user to turn on the information device not ready for the settings change on the change date and time when the device status controlling part 44 cannot make the information device not ready for the settings change become ready for the settings change. So, the notified user turns on the information device on the change date and time by manual, thereby making the information device become ready for the settings change.

According to the present preferred embodiment, it is determined whether or not each of the plurality of information devices 3a, 3b, 3c and 3d is being ready for the setting change at the same time as the scheduled change time on the day before the scheduled change date. If there are one or more of the plurality of information devices 3a, 3b, 3c and 3d are determined to be not ready for the settings change, the device not ready for the settings change is caused to become ready for the settings change on the change date and time. The occurrence of devices, therefore, the settings for which being failed to be changed on the change date and time when the settings for every device should be changed collectively may be reduced.

### (Modifications)

While the present preferred embodiment of the present invention has been described above, the present invention is not limited to the present preferred embodiment. Various modifications may be applied to the present invention.

Since the information processing device 1 of the present preferred embodiment described above is formed from the server computer, it may be formed from other devices such as the general personal computer (PC), for example.

In the above-described present preferred embodiment, each of the plurality of information devices 3a, 3b, 3c and 3d is one of the MFPs, the printer, the facsimile or other devices. The information devices 3a, 3b, 3c and 3d are not limited to such devices. The information devices 3a, 3b, 3c and 3d should be the devices, the settings for which are allowed to be changed through the network 4.

What is claimed is:

1. An information processing device connected with a plurality of devices through a network, comprising:
a scheduling part for configuring a change date and time to change settings for each of said plurality of devices;
a device status determination part for determining if each of said plurality of devices is ready for settings change at the same time as said scheduled change time on the day before said scheduled change date;
a device status controlling part for causing the device not ready for the settings change to become ready for the settings change on said scheduled change date and time when it is determined by said device status determination part that one or more of said plurality of devices are not ready for the settings change; and
a settings changing part for changing the settings for each of said plurality of devices on said scheduled change date and time.

2. The information processing device according to claim 1, wherein
said device status controlling part designates in advance a data transmission form, data transmission in which allows the device not ready for the settings change to become ready for the settings change with at least one data transmission to the device in cases where the device is determined by said device status determination part to be not ready for the settings change, and transmits data in the form designated in advance to the device not ready for the settings change, thereby causing the device not ready for the settings change to become ready for the settings change on said scheduled change date and time.

3. The information processing device according to claim 1, further comprising:
a monitoring part for monitoring an operation status of each of said plurality of devices by periodically and recording as status monitoring information, wherein
said device status controlling part identifies the time when the device determined by said device status determination part to be not ready for the settings change becomes ready for the settings change prior to said scheduled change date and time by referring to said status monitoring information and configures at the identified time the device determined to be not ready for the settings change to turn on automatically on said scheduled change date and time.

4. The information processing device according to claim 3, wherein
said device status controlling part configures the device made automatically turn on to turn off after the settings are changed by said settings changing part.

5. The information processing device according to claim 3, wherein
said settings changing part, if there are one or more of said plurality of devices, the settings for which are failed to be changed on said scheduled change date and time, predicts the time when the device, the settings for which failed to be changed becomes ready for the settings change with said status monitoring information and changes the settings at the predicted time when the device becomes ready for the settings change.

6. The information processing device according to claim 5, further comprising:
a rewriting part for rewriting history information recorded between said scheduled change date and time and the time of completion of the settings change in response to completion of the settings change by said settings changing part.

7. The information processing device according to claim 1, further comprising:
a notification part, when said device status controlling part fails to make the device not ready for the settings change become ready for the settings change, for notifying a predetermined user to turn on the device determined by said device status determination part to be not ready for the settings change on said scheduled change date and time.

8. A settings changing method for changing settings for a plurality of devices connected together through a network, the method comprising the steps of:
(a) configuring a change date and time to change the settings for each of said plurality of devices;
(b) determining if each of said plurality of devices is ready for settings change at the same time as said scheduled change time on the day before said scheduled change date;
(c) causing the device not ready for the settings change to become ready for the settings change on said scheduled change date and time when it is determined in said step (b) that one or more of said plurality of devices are not ready for the settings change; and
(d) changing the settings for each of said plurality of devices on said scheduled change date and time.

9. The settings changing method according to claim 8, wherein
in said step (c), a data transmission form, data transmission in which allows the device not ready for the settings change to become ready for the settings change is designated in advance with at least one data transmission to the device in cases where the device is determined in said step (b) to be not ready for the settings change, and data is transmitted in the form designated in advance to the device not ready for the settings change, so that the device not ready for the settings change is caused to become ready for the settings change on said scheduled change date and time.

10. The settings changing method according to claim 8, further comprising:
(e) monitoring an operation status of each of said plurality of devices by periodically and recording as status monitoring information, wherein
in said step (c), the time when the device determined in said step (b) to be not ready for the settings change becomes ready for the settings change prior to said scheduled change date and time is identified with reference to said status monitoring information and the device determined to be not ready for the settings change is configured at the identified time to turn on automatically on said scheduled change date and time.

11. The settings changing method according to claim 10, wherein
in said step (c), the device made automatically turn on is configured to turn off after the settings are changed in said step (d).

12. The settings changing method according to claim 10, wherein
in said step (d), if there are one or more of said plurality of devices, the settings for which are failed to be changed on said scheduled change date and time, the time when the device, the settings for which failed to be changed becomes ready for the settings change is predicted with said status monitoring information and the settings are changed at the predicted time when the device becomes ready for the settings change.

13. The settings changing method according to claim 12, further comprising:
(f) rewriting history information recorded between said scheduled change date and time and the time of completion of the settings change in response to completion of the settings change in said step (d).

14. The settings changing method according to claim 8, further comprising:
(g) notifying a predetermined user to turn on the device determined in said (b) to be not ready for the settings change on said scheduled change date and time when the device not ready for the settings change is failed to be made ready for the settings change in said step (c).

15. A computer readable recording medium on which a program is recorded executable by an information processing device connected together with a plurality of devices through a network, said program causing said information processing device to function as a system comprising:
a scheduling part for configuring a change date and time to change settings for each of said plurality of devices;
a device status determination part for determining if each of said plurality of devices is ready for settings change at the same time as said scheduled change time on the day before said scheduled change date;
a device status controlling part for causing the device not ready for the settings change to become ready for the settings change on said scheduled change date and time when it is determined by said device status determination part that one or more of said plurality of devices are not ready for the settings change; and
a settings changing part for changing the settings for each of said plurality of devices on said scheduled change date and time.

16. The computer readable recording medium according to claim 15, wherein
said device status controlling part designates in advance a data transmission form, data transmission in which allows the device not ready for the settings change to become ready for the settings change with at least one data transmission to the device in cases where the device is determined by said device status determination part to be not ready for the settings change, and transmits data in the form designated in advance to the device not ready for the settings change, thereby causing the device not ready for the settings change to become ready for the settings change on said scheduled change date and time.

17. The computer readable recording medium according to claim 15, further comprising:
a monitoring part for monitoring an operation status of each of said plurality of devices by periodically and recording as status monitoring information, wherein
said device status controlling part identifies the time when the device determined by said device status determination part to be not ready for the settings change becomes ready for the settings change prior to said scheduled change date and time by referring to said status monitoring information and configures at the identified time the device determined to be not ready for the settings change to turn on automatically on said scheduled change date and time.

18. The computer readable recording medium according to claim 17, wherein
said device status controlling part configures the device made automatically turn on to turn off after the settings are changed by said settings changing part.

19. The computer readable recording medium according to claim 17, wherein
said settings changing part, if there are one or more of said plurality of devices, the settings for which are failed to be changed on said scheduled change date and time, predicts the time when the device, the settings for which failed to be changed becomes ready for the settings change with said status monitoring information and changes the settings at the predicted time when the device becomes ready for the settings change.

20. The computer readable recording medium according to claim 15, further comprising:
a notification part, when said device status controlling part fails to make the device not ready for the settings change become ready for the settings change, for notifying a predetermined user to turn on the device determined by said device status determination part to be not ready for the settings change on said scheduled change date and time.
